(19) United States
(12) Patent Application Publication
(10) Pub. No.: US 2025/0308151 A1
(43) Pub. Date: Oct. 2, 2025

(54) SYSTEM AND METHOD FOR DETERMINING VISUAL PERCEPTION OF 3-DIMENSIONAL (3D) OBJECTS

(71) Applicant: Panasonic Intellectual Property Management Co., Lid., Osaka (JP)

(72) Inventors: Myo MIN LATT, Singapore (SG); Aimin ZHAO, Singapore (SG); Nway Nway AUNG, Singapore (SG); Eng Chye LIM, Singapore (SG); Kyaw Myo HTUN, Singapore (SG); Faye JULIANO, Singapore (SG)

(21) Appl. No.: 18/617,353

(22) Filed: Mar. 26, 2024

(51) Int. Cl. G06T 17/00; G06T 7/12; G06T 7/13; G06T 7/246; G06T 7/73; G06V 10/46; G06V 10/774

(52) U.S. Cl. CPC G06T 17/00; G06T 7/12; G06T 7/13; G06T 7/246; G06T 7/73; G06V 10/46; G06V 10/774

(57) ABSTRACT

A method for determining a visual perception of 3-dimensional (3D) objects in a real scene. The method includes segmenting the 3D objects into segmented data comprising of rigid objects and non-rigid objects. Further, the method includes determining a position and a shape for the segmented 3D objects. The position indicates a set of coordinates, and the shape indicates a sequence of a set of key points. Furthermore, the method includes tracking movement of the segmented 3D objects. Furthermore, the method includes determining the visual perception of the segmented 3D objects based on the tracked movement. The visual perception indicates the shape and location of the rigid objects and the non-rigid objects in the real scene.

### FIELD OF THE INVENTION

The present invention generally relates to computer vision techniques and more particularly relates to 3-dimensional (3D) object identification and tracking.

### BACKGROUND

Industrial automation has revolutionized manufacturing processes, bringing efficiency and precision to various industries. A crucial aspect of this evolution is the ability of automation systems to handle a diverse range of 3-Dimensional (3D) objects, encompassing both rigid and non-rigid types. While dealing with rigid objects poses its own set of challenges, addressing the intricacies of non-rigid objects demands a higher level of sensing intelligence within the automation system.

Handling non-rigid 3D objects within the automation system poses a myriad of challenges, distinguishing them from their rigid counterparts. For instance, the infinite configurations that non-rigid objects may assume, pose a significant hurdle for traditional computer vision techniques. Unlike rigid objects with well-defined shapes and structures, non-rigid objects, such as deformable materials, may change shape and form unpredictably. This variability makes it challenging to develop robust computer vision techniques/algorithms that can effectively identify and track non-rigid objects within the automation system.

Moreover, unexpected occlusion cases further compound the difficulty in effectively handling non-rigid objects. Occlusion occurs when one object obscures another, and in industrial settings, this phenomenon is unpredictable, especially when dealing with materials that can change shape. Traditional computer vision techniques may struggle to cope with such occlusion scenarios, leading to potential errors in object recognition and tracking.

Another significant challenge lies in obtaining high-quality training data for developing a robust vision perception system capable of handling a wide range of industrial automation applications. Unlike rigid objects, which have more standardized features, non-rigid objects exhibit a vast array of deformations and variations. Acquiring diverse and representative training data that covers the full spectrum of non-rigid object configurations becomes a complex task, impacting the effectiveness of the computer vision technique (automation system).

Thus, due to the evolving landscape of industrial automation demands, there is a need for adaptive systems which are capable of handling the complexities introduced by non-rigid 3D objects. By acknowledging the challenges associated with infinite configurations, unexpected occlusions, and data scarcity, there is a requirement for developing robust visual perception systems for computer vision techniques.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to one embodiment of the present disclosure, a method for determining a visual perception of one or more 3-dimensional (3D) objects in an environment. The method includes segmenting the one or more 3D objects into segmented data comprising of one or more rigid objects and one or more non-rigid objects in a user input using a segmentation machine learning (ML) model, wherein the user input indicates a representation of the environment. Further, the method includes determining a set of key points corresponding to each of the segmented one or more 3D objects based on an orientation of the segmented one or more 3D objects, the user input and corrected segmented point cloud data, wherein the set of key points indicates spatial characteristics of the segmented one or more 3D objects. Furthermore, the method includes determining a position and a shape of the corresponding segmented one or more 3D objects based on a corrected segmented point cloud data and the set of key points, wherein the position indicates a set of coordinates, and the shape indicates a sequence of the set of key points. Furthermore, the method includes tracking a movement of the segmented one or more 3D objects based on the set of key points, the corrected segmented point cloud data, and a motion value corresponding to a manipulator attached to the one or more 3D objects. Furthermore, the method includes determining the visual perception of the segmented one or more 3D objects based on the tracked movement and the set of key points, wherein the visual perception indicates the shape and a location of the one or more rigid objects and the one or more non-rigid objects in the environment.

According to one embodiment of the present disclosure, a system for determining a visual perception of one or more 3-dimensional (3D) objects in an environment. The system includes a memory and at least one processor in communication with the memory. The at least one processor is configured to segment the one or more 3D objects into segmented data comprising of one or more rigid objects and one or more non-rigid objects in a user input using a segmentation machine learning (ML) model, wherein the user input indicates a representation of the environment. Further, the at least one processor is configured to determine a set of key points corresponding to each of the segmented one or more 3D objects based on an orientation of the segmented one or more 3D objects, the user input, and the corrected segmented point cloud data, wherein the set of key points indicates spatial characteristics of the segmented one or more 3D objects. Furthermore, the at least one processor is configured to determine a position and a shape of the corresponding segmented one or more 3D objects based on a corrected segmented point cloud data and the set of key points, wherein the position indicates a set of coordinates, and the shape indicates a sequence of the set of key points. Furthermore, the at least one processor is configured to track a movement of the segmented one or more 3D objects based on the set of key points, the corrected segmented point cloud data, and a motion value corresponding to a manipulator attached to the one or more 3D objects. Furthermore, the at least one processor is configured to determine the visual perception of the segmented one or more 3D objects based on the tracked movement and the set of key points, wherein the visual perception indicates the shape and a location of the one or more rigid objects and the one or more non-rigid objects in the environment.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment for the implementation of a system for determining a visual perception of 3-dimensional (3D) objects in the environment, according to an embodiment of the present invention;

FIG. 2 illustrates a schematic block diagram of components of the system for determining the visual perception of 3D objects, according to an embodiment of the present invention;

FIG. 3 illustrates an exemplary process flow for training an untrained segmentation machine learning model, according to an embodiment of the present invention;

FIG. 4 illustrates another exemplary process flow of the segmentation module of the system, according to an embodiment of the present invention;

FIG. 5 illustrates an exemplary process flow of a filtering module of the system, according to an embodiment of the present invention;

FIG. 6 illustrates an exemplary process flow of a feature and shape detection module of the system, according to an embodiment of the present invention;

FIG. 7 illustrates an exemplary process flow of a tracking module of the system, according to an embodiment of the present invention; and

FIG. 8 illustrates an exemplary process flow comprising a method for determining the visual perception of 3D objects, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect,” “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

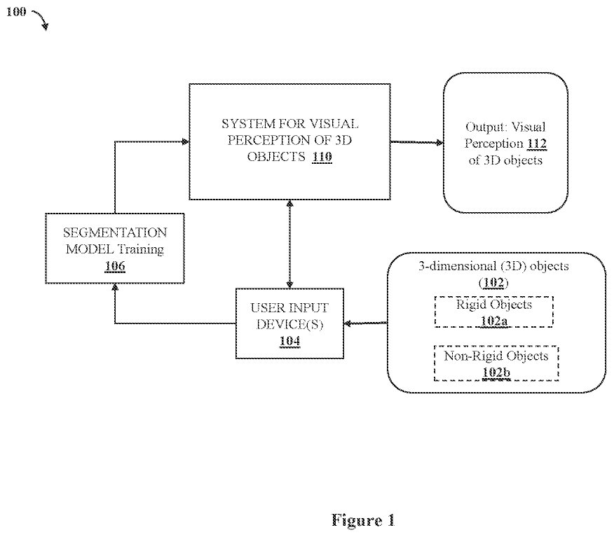

FIG. 1 illustrates a schematic block diagram depicting an environment 100 for the implementation of a system 110 for determining a visual perception of 3-dimensional (3D) objects in the environment, according to an embodiment of the present invention. For the sake of brevity, the system 110 for determining the visual perception of the 3D objects in the environment is hereinafter interchangeably referred to as the system 110.

In an embodiment, referring to FIG. 1, the system 110 may be implemented between one or more 3D objects 102 and a user input device 104. In an example, the one or more 3D objects 102 are hereinafter referred to as the 3D objects 102 for the sake of brevity. The 3D objects 102 may correspond to entities that exist in a three-dimensional environment/space 100 including one or more rigid objects 102a and one or more non-rigid objects 102b. In the example, one or rigid objects 102a, hereinafter referred to as the rigid objects 102a for the sake of brevity, corresponds to a fixed structure incapable of deformation. In the example, one or non-rigid objects 102b, hereinafter referred to as the non-rigid objects 102b for the sake of brevity, corresponds to a flexible structure capable of deformation or change in shape.

Further, in the example, the user input device 104 may correspond to a camera sensor configured to generate a user input. In a non-limiting example, the user input device 104 may indicate a physical device that captures visual information from the environment 100 and converts it into electronic signals. This user input device 104 is an essential component in the process of generating realistic simulation 3D models, as the user input device 104 may be configured to capture both the user input (colour data and depth data) to provide input for the simulation 3D models.

In the example, the user input may indicate 3D data, colour data, and depth data. In the example, the colour data refers to Red, Green, and Blue (RGB) data from the camera sensor (user input device 104) that represents the colour information captured in an image. In the RGB data, each pixel may be assigned values for the intensity of red, green, and blue colors. Consequently, combining these colour values for each pixel creates a full-color image. Thus, the RGB data may provide information about the appearance and colour of the 3D objects 102 in the environment 100. For instance, the camera sensor (user input device 104) may capture an image of a scene or the environment 100, the RGB data for each pixel may describe the color of that pixel in terms of the intensities of red, green, and blue light. Thus, RGB data may be essential for creating realistic visual simulations as it represents the visual appearance of the 3D objects 102.

Similarly, the depth data captured by the user input device 104 may provide information about the distance of 3D objects 102 from the user input device 104. The depth data may measure the depth or the spatial arrangement of 3D objects 102 in the environment 100. Unlike the RGB data, which captures colour information, the depth data may be typically represented as a grayscale image, where each pixel corresponds to a distance value. Thus, depth data may be crucial for creating realistic 3D models as depth data provides the spatial relationships between different 3D objects 102. Furthermore, the depth data may enable the generation of depth cues, such as occlusion and perspective, which contribute to the overall perception of depth in a simulated scene.

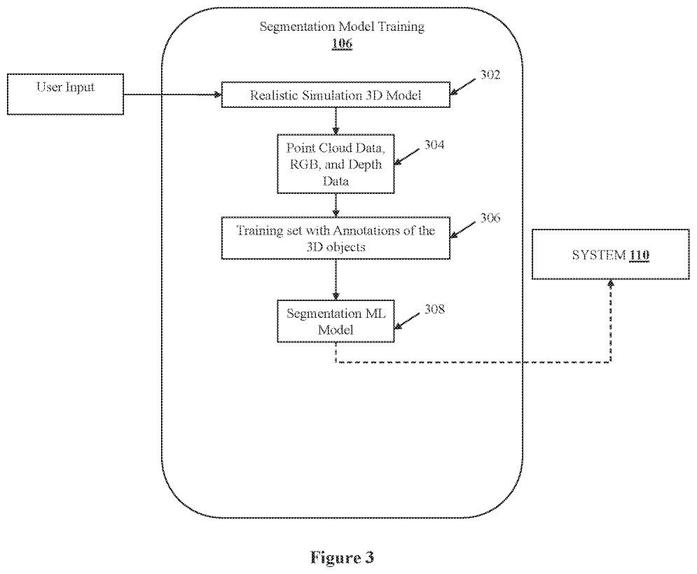

The user input device 104 may be in communication with the system 110. The system 110 may be configured to determine the visual perception of the 3D objects 102 within the environment 100. Further, the system 110 may be configured to utilize a trained segmentation model to segment 3D object data and apply feature and shape detection algorithms alongside probability-based 3D registration techniques to generate an output. In an example, a segmentation machine learning (ML) model may be trained using point cloud data, RGB data, and the depth data. A detailed explanation for the training of an untrained segmentation ML model is provided in FIG. 3. Consequently, the system 110 may be configured to generate the output indicative of determining the visual perception 112 of the 3D objects 102. In an example, the visual perception 112 (output) refers to the accurate estimation of the 3D shape and location of both the rigid objects 102a and the non-rigid objects 102b in static and dynamic scenes corresponding to the environment 100. The following paragraphs provide a detailed explanation of the working of the system 110.

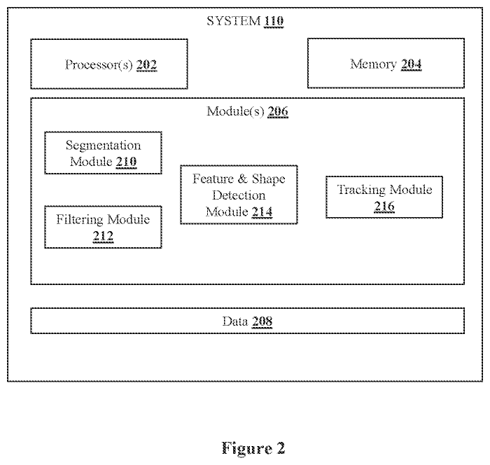

FIG. 2 illustrates a schematic block diagram of modules/software components of the system 110 for determining the visual perception 112 of the 3D objects 102, according to an embodiment of the present invention.

The system 110 may include, but is not limited to, at least one processor 202 (alternatively referred to as processor), memory 204, modules 206, and data 208. The modules 206 and the memory 204 may be communicably coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 can be implemented in hardware, instructions executed by a processing unit, or by a combination thereof. The processing unit can comprise a computer, a processor, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software) which, when executed by a processor/processing unit, perform any of the described functionalities.

In an embodiment, the modules 206 may include a segmentation module 210, a filtering module 212, a feature and shape detection module 214, and a tracking module 216. The segmentation module 210, the filtering module 212, the feature and shape detection module 214, and the tracking module 216 may be in communication with each other. The data 208 serves, amongst other things, as a repository for storing data processed, received, and generated by one or more of the modules 206.

Referring to FIG. 1 and FIG. 2 the segmentation module 210 may be configured to segment the 3D objects 102 in the user input, into segmented data. The segmented data or the segmented 3D objects 102 may indicate distinct categorization of the rigid objects 102a and the non-rigid objects 102b in the user input, segmented using the segmentation machine learning (ML) model, i.e., trained using point cloud data, color data, and depth data. Further, the segmentation ML model may be configured to generate segmented point cloud data based on the segmented data. Consequently, the segmentation ML model via the segmented point cloud data identifies and isolates the contour for each of the segmented the rigid objects 102a and the non-rigid objects 102b respectively.

In an embodiment, the filtering module 212 may be configured to correct errors in the segmented data using an image processing technique to provide corrected segmentation of the 3D objects 102.

In an embodiment, the feature and shape detection module 214 may be configured to determine a set of key points corresponding to each of the segmented 3D objects 102 (rigid objects 102a and non-rigid objects 102b) based on an orientation of the segmented 3D objects 102, the user input and the corrected segmented point cloud data. In an example, the set of key points may indicate spatial characteristics of the segmented 3D objects 102. Further, the feature and shape detection module 214 may be configured to determine a position and a shape of the corresponding segmented 3D objects 102 based on the corrected segmented point cloud data and the set of key points. In an example, the position of the segmented 3D objects 102 may indicate a set of coordinates, and the shape of the segmented 3D objects 102 may indicate a sequence of the set of key points.

In an embodiment, the tracking module 216 may be configured to track a movement of the segmented 3D objects 102 based on the set of key points, the corrected segmented point cloud data, and a motion value corresponding to a manipulator attached to the 3D objects 102. Further, the tracking module 216 may be configured to determine the visual perception 112 of the segmented 3D objects 102 based on the tracked movement and the set of key points. In the example, the visual perception may indicate the shape and the location of the rigid objects 102a and the non-rigid objects 102b in the environment 100. Accordingly, an explanation of each of the modules 206 is detailed in the following paragraphs.

FIG. 3 illustrates an exemplary process flow for the training of the untrained segmentation ML model 106, according to an embodiment of the present invention.

In an embodiment, at step 302, a realistic simulation 3D model may be configured to receive the user input (3D data, colour data, depth data) from the user input device 104. In an example, the user input device 104 (the camera sensor) may capture information about the 3D structure of the environment (3D data), the colour information of the scene (colour data), and the spatial distances to objects (depth data). Thus, the user input may serve as the raw data source for subsequent processing. Further, the realistic 3D simulation model may represent a computer-generated simulation that closely mimics the characteristics and behaviours of real-world objects (3D objects 102) and environment 100 in three-dimensional space. The characteristics may include detailed models of objects, lighting conditions, and physical properties. In an example, the realistic 3D simulation model may be adapted to provide the point cloud data. In another example, the realistic 3D simulation model may simulate different scenarios to test and optimize the performance of the segmentation ML model.

At step 304, the realistic simulation 3D model may be configured to simulate a variety of scenarios, including the 3D objects 102 (in the real world). Consequently, the realistic simulation 3D model may be configured to generate spatial information associated with the 3D objects 102. In an example, the spatial information is referred to as point cloud data. Subsequently, in the step 304, the point cloud data may be merged with the color data (RGB data) and the depth data for the training of the untrained segmentation ML model 106. Thus, the point cloud data represents the spatial information of the 3D objects 102 within the simulated environment. Further, the point cloud data may be a collection of points in 3D space, and each point corresponds to a location where the simulated object exists. Consequently, a synthetic training dataset may be generated, that mimics the spatial layout of objects in a real-world environment. Subsequently, the point cloud data, the color data (RGB data) and the depth data may be valuable for training machine learning models (segmentation ML model), particularly for tasks such as object recognition and segmentation.

At step 306, the point cloud data, the color data (RGB data) and the depth data are then utilized to create a training set for the training of the untrained segmentation ML model (machine learning purposes). The training set includes annotating the point cloud data, specifying which points correspond to different types of objects and categorizing them into one of two categories for instance the rigid objects 102a or the non-rigid objects 102b. The training set, therefore, includes both the spatial information (from the point cloud data), the color data (RGB data), the depth data and annotations classifying the 3D objects 102 into rigid or non-rigid categories. This annotated training set becomes crucial for training machine learning models, such as segmentation models, to recognize and distinguish between these different object types.

At step 308, the segmentation ML model may be trained with the training set as generated in the previous step. In an example, the segmentation ML model learns from the training dataset, utilizing supervised learning techniques to recognize patterns and features associated with different object types.

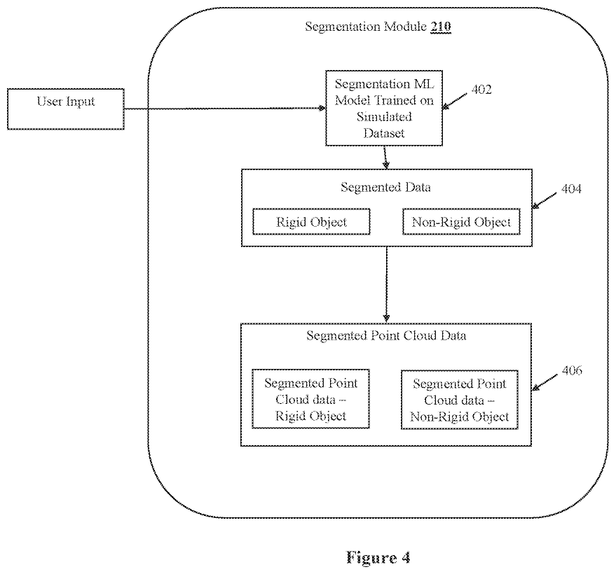

FIG. 4 illustrates another exemplary process flow of the segmentation module 210 of the system 110, according to an embodiment of the present invention.

In an embodiment, at step 402 the segmentation ML model trained with the training dataset receives the user input via the user input device 104.

At step 404, the segmentation ML model may be configured to generate the segmented data. In an example, the segmented data may include the segmentation of the 3D objects 102 in the user input into distinct categories, specifically identifying and classifying the segmented 3D objects into two main groups i.e., the rigid objects 102a and the non-rigid objects 102b. Through this segmentation process, the segmentation ML model may precisely delineate and label each of the 3D objects 102 within the user input, providing a detailed and categorized representation that distinguishes between objects with stable structures (rigid) and those capable of deformation or changes in shape (non-rigid.

At step 406, the segmentation ML model may be configured to generate a segmented point cloud data. In an example, the segmentation ML model may be configured to merge the segmented data (segmented mask) with the depth projection to generate segmented point cloud data. The segmented point cloud data may encapsulate the spatial information of the 3D objects 102 and may be enhanced by the segmentation distinctions made by the segmentation ML model. Further, each point in the segmented point cloud data may correspond to a specific location in the 3D space with the categorization as generated in the segmented data. Specifically, the segmentation ML model identifies and isolates the contour for each of the segmented 3D objects 102.

In the example, the segmentation ML model may be configured to identify and isolate contours in the user input (color data and the depth data). In the example, the segmentation ML model may be configured to recognize patterns and features within the user input, thus tailoring its approach for categorization of the rigid objects 102a and non-rigid objects 102b separately. For instance, for the rigid objects 102a, the segmentation ML model may isolate contours that define the stable structures, ensuring precise identification. Simultaneously, for the non-rigid objects 102b, the segmentation ML model may adapt to the deformable nature, identifying contours that capture the variations in shape. Thus, generating the segmented point cloud data for each of the rigid objects 102a and the non-rigid objects 102b.

In an example, the generation of the segmented point cloud data may facilitate a more accurate estimation of the 3D shape and location of the 3D objects 102, as mentioned in the previous paragraphs, also enabling a more detailed analysis of object contours. Consequently, the segmented point cloud data contributes to a higher fidelity in understanding the spatial characteristics of both the rigid objects 102a and the non-rigid objects 102b within static and dynamic scenes.

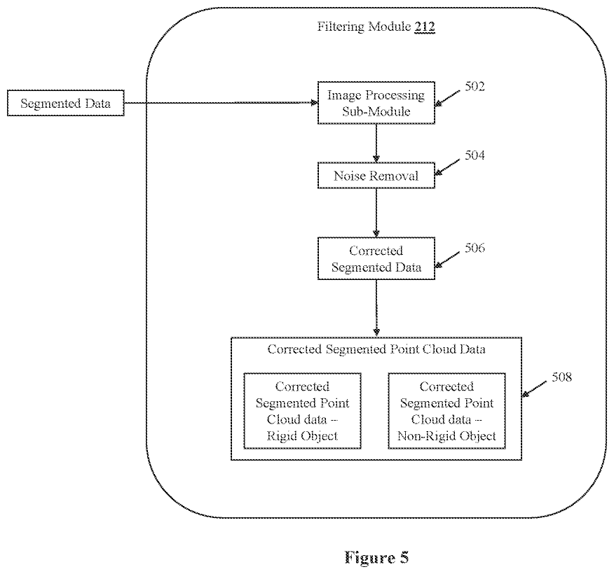

FIG. 5 illustrates an exemplary process flow of the filtering module 212 of the system 110, according to an embodiment of the present invention. In an embodiment, the filtering module 212 may be configured to form a process of refining and correcting the segmented data obtained from the segmentation of the 3D objects 102. The filtering module 212 may include an image processing sub-module, to enhance the accuracy, reduce noise, rectify inaccuracies, and ultimately generate a corrected segmented point cloud data that forms a foundation for subsequent tasks in the system for determining the visual perception 112.

At step 502, the filtering module 212 may include the image processing sub-module. In an example, the segmented data, which results from the segmentation process, is passed to the image processing sub-module. The image processing sub-module may be configured to enhance and refine the accuracy of the segmentation data by addressing potential errors introduced during the segmentation of the 3D objects 102.

At step 504, the filtering module 212 may be configured to remove noise present in the segmented data via the image processing sub-module. In an example, the segmented data may include unwanted artefacts or inaccuracies referred to as the noise. In the example, the noise is generally a result of complexities in the scene (environment), occlusions, or limitations of the segmentation ML model. Thus, the image processing sub-module focuses on noise reduction. Consequently, employing techniques to filter out irrelevant or erroneous details in the segmented data, thus ensuring that the segmented data is cleaner and more representative of the actual objects in the scene.

At step 506, once the noise is removed the filtering module 212 may be configured to rectify inaccuracies or discrepancies present in the segmented data. In an example, the filtering module 212 may be configured to address any misclassifications or errors introduced during the segmentation process, especially in scenarios where the scene is complicated. Consequently, the filtering module 212 may be configured to apply corrections to ensure that the segmented data more accurately reflects the true boundaries and characteristics of the 3D objects 102 within the scene.

At step 508, the filtering module 212 may be configured to utilize the corrected segmented data for the generation of a corrected segmented point cloud. In an example, the corrected segmented point cloud may represent the spatial information of the segmented 3D objects 102. Consequently, the filtering module 212 may be configured to incorporate the corrections made in the previous steps, thus the resulting corrected segmented point cloud data provides a more precise and reliable representation of the 3D objects 102. Accordingly, the corrected segmented point cloud data captures the refined contours and spatial characteristics, addressing any errors introduced during the segmentation process and ensuring the fidelity of the point cloud representation. It may be apparent to an ordinary person skilled in the art that the corrected segmented data and the corrected segmented point cloud data may be used in the processing further to determine the visual perception.

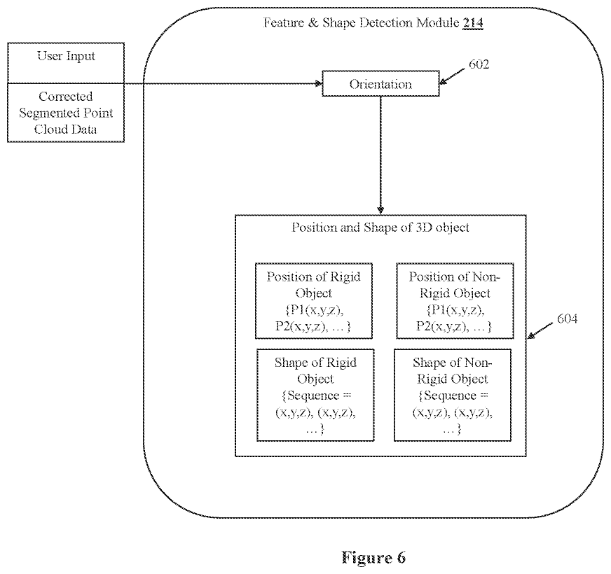

FIG. 6 illustrates an exemplary process flow of the feature and shape detection module 214 of the system 110, according to an embodiment of the present invention.

At step 602, the feature and shape detection module 214 may be configured to determine an orientation of the segmented 3D objects 102. In an example, the orientation refers to the spatial positioning and alignment information for the segmented 3D objects 102 (segmented data). The orientation may be derived from the corrected segmented point cloud data thus indicating the alignment of the objects in the three-dimensional space. Consequently, the feature and shape detection module 214 through the orientation may be configured to determine the relative positioning of the 3D objects 102, which may be essential for subsequent analysis. Thus, the determination of the orientation by the feature and shape detection module 214 may be foundational for achieving accurate spatial representation and alignment of objects within the scene.

At step 604, following the determination of the orientation, the feature and shape detection module 214 may be configured to determine a position and a shape of the segmented 3D objects. The position and the shape may include a set of key points (x,y,z) corresponding to the segmented 3D objects 102 (segmented data) for determining a precise position and shape of the segmented 3D objects. In an example, the set of key points may indicate spatial characteristics, encompassing features such as edges, surface landmarks, junctions, protuberances, and high curvature points. The set of key points may be a representation of the 3D objects 102 unique geometry and structure, providing a detailed descriptor associated with the spatial characteristics. In the example, the set of key points may capture both rigid and non-rigid aspects of the segmented 3D objects 102 (segmented data), thus, accommodating variations in object deformations. In another example, the feature and shape detection module 214 may be configured to determine the set of key points using the corrected segmented point cloud data generated by the filtering module 212.

In an example, the position may be indicated as a set of coordinates (positional) corresponding to the set of key points, [P1(x,y,z), P2(x,y,z) . . . ] thus revealing the location of the 3D objects 102 in the 3D space. Simultaneously, the feature and shape detection module 214 may be configured to determine the shape of the segmented 3D objects 102 based on an order of the set of key points. In an example, the shape may be indicated as a sequence of the set of key points. In the example, the sequence may encapsulate the geometry and structure of the 3D objects 102, thus offering a comprehensive representation of its spatial characteristics. Consequently, the feature and shape detection module 214 by combining information from the corrected segmented point cloud data and the user input refines the understanding of the segmented 3D objects 102 spatial attributes, facilitating accurate analysis of positions and shapes of the segmented 3D objects 102 within the scene.

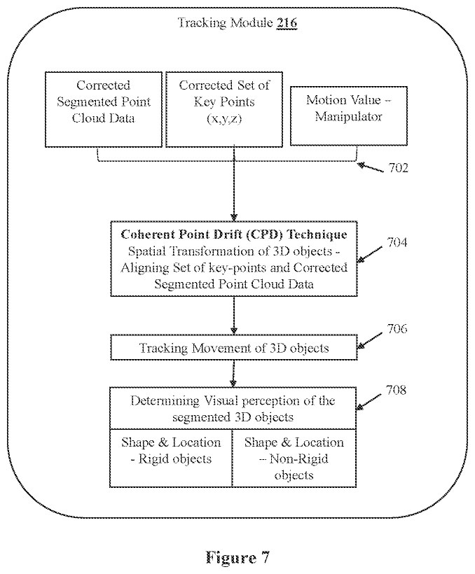

FIG. 7 illustrates an exemplary process flow of the tracking module 216 of the system 110, according to an embodiment of the present invention.

In an embodiment, at step 702, the tracking module 216 may be configured to receive a corrected set of key points at a first timestamp Simultaneously, the tracking module 216 may be configured to receive the corrected segmented point cloud data at the second timestamp, representing the current state of the 3D scene. Additionally, the tracking module 216 may be configured to receive the motion value of a manipulator, for instance, a robotic arm. In an example, the manipulator may be configured to transport the 3D objects 102. The integration of the inputs at different timestamps sets the stage for tracking and understanding the movement of the 3D objects 102 in the scene.

At step 704, the tracking module 216 may be configured to determine a spatial transformation. In an example, the spatial transformation may indicate aligning the corrected set of key points from the first timestamp with the corrected segmented point cloud data from the second timestamp. In the example, the alignment is critical for tracking and understanding the movement of the 3D objects 102 over time. In the example, a Coherent Point Drift (CPD) technique may be used for determining the spatial transformation. In the example, the CPD is a probability-based 3D registration technique that handles complex spatial transformations, thus accurately aligning the set of key points and the corrected segmented point cloud data. Consequently, the tracking module 216 may be configured to adapt to variations and transformations in the scene, providing a refined understanding of the 3D objects 102 movement.

At step 706, the tracking module 216 may be configured to utilize the determined spatial transformation to track the movement of the segmented 3D objects 102. In an example, the tracking module 216 may apply the spatial transformation, to follow the trajectory and changes in the position of the segmented 3D objects 102 over time. Thus, the tracking process is crucial for tasks such as real-time monitoring, control, or interaction with the dynamic environment. Further, the manipulator's motion value, contributes to this tracking process, indicating the potential changes introduced by the robotic arm (manipulator) in the scene. Consequently, the tracking module 216 provides a continuous and updated understanding of how the segmented 3D objects 102 move within the environment 100, facilitating responsive and adaptive actions as needed.

At step 708, the tracking module 216 may be configured to correlate the tracked movement information and the corrected set of key points to determine the visual perception 112 of the segmented 3D objects 102. Thus, this step is fundamental for understanding the spatial attributes of the 3D objects 102 in the dynamic environment.

In an example, the tracking module 216 tracks the movement of the segmented 3D objects 102 over time, thus utilizing the spatial transformation obtained in step 704. In the example, the tracked movement provides a continuous record of how the 3D objects 102 have changed their positions and orientations. The tracked movement may be a dynamic representation that captures the evolving nature of the scene, influenced by external factors such as the manipulator's motion. Further, the visual perception 112 refers to the holistic understanding of the segmented 3D objects 102. In the example, determining the visual perception includes synthesizing information about the shape and location of both the rigid objects 102a and the non-rigid objects 102b in the environment 100. The visual perception thus provides a detailed and accurate representation of the 3D objects 102 existence in the 3D space.

Consequently, in the example, the tracking module 216 may be configured to determine the visual perception of the segmented 3D objects i.e., determining the shape and location of the segmented 3D objects. In the example, the shape may be indicated by the sequence of the set of key points, thus capturing the intricate details of each object's geometry. Simultaneously, the location may be indicated by the set of coordinates, specifying where each object is situated in the environment 100. This comprehensive understanding enables the system 110 to visualize and interpret the scene with precision, facilitating further decision-making or interaction in applications like robotics, automation, or augmented reality.

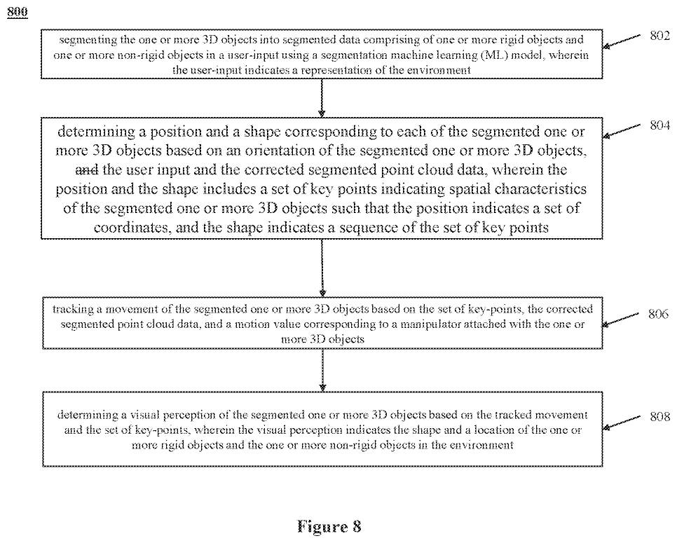

FIG. 8 illustrates an exemplary process flow comprising a method 800 for determining the visual perception of 3D objects, according to an embodiment of the present invention, according to an embodiment of the present invention. The method 800 may be a computer-implemented method executed, for example, by the processor 202 and the modules 206. For the sake of brevity, constructional and operational features of the system 110 that are already explained in the description of FIG. 1, FIG. 2, FIG. 3, FIG. 4, FIG. 5, FIG. 6, and FIG. 7 are not explained in detail in the description of FIG. 8.

At step 802, the method 800 may include segmenting the 3D objects 102 into segmented data comprising of one or more rigid objects and one or more non-rigid objects in the user input using the segmentation ML model. The user input may indicate a representation of the environment 100.

At step 804, the method 800 may include determining a position and a shape corresponding to each of the segmented one or more 3D objects based on an orientation of the segmented one or more 3D objects, the user input and the corrected segmented point cloud data, wherein the position and the shape includes a set of key points indicating spatial characteristics of the segmented one or more 3D objects such that the position indicates a set of coordinates, and the shape indicates a sequence of the set of key points.

At step 806, the method 800 may include tracking the movement of the segmented 3D objects based on the set of key points, the corrected segmented point cloud data, and the motion value corresponding to the manipulator attached to the 3D objects 102.

At step 808, the method 800 may include determining the visual perception of the segmented 3D objects 102 based on the tracked movement and the set of key points. The visual perception may indicate the shape and the location of the rigid objects 102a and the non-rigid objects 102b in the environment 100.

While the above discussed steps in FIGS. 3-7 are shown and described in a particular sequence, the steps may occur in variations to the sequence in accordance with various embodiments. Further, a detailed description related to the various steps of FIG. 8 is already covered in the description related to FIGS. 3-7 and is omitted herein for the sake of brevity.

The present invention provides various advantages:
The present invention facilitates superior decision-making capabilities by providing a comprehensive understanding of the 3D shapes of objects. This enriched perception enables more informed and precise decision-making processes across various applications.
The present invention uses detailed 3D shape information to identification abnormal conditions exhibited by objects. This proactive identification enhances safety measures and allows for timely intervention in scenarios where deviations from expected object conditions occur.
The present invention's ability to predict 3D shape even in instances of heavy occlusion ensures robust performance under challenging conditions. This capability mitigates the risk of system failures, particularly in unexpected scenarios, by maintaining accurate object perception even when partially obscured.
The present invention provides a versatile method to handle both rigid and non-rigid objects within the realm of industrial automation. This flexibility ensures that the system adapts seamlessly to diverse object types encountered in industrial settings, contributing to the overall efficiency and adaptability of automation processes.
The present invention enhances object recognition and segmentation accuracy, leading to a more precise understanding of the spatial characteristics of objects. This improvement is particularly valuable in applications where detailed object analysis is critical, such as quality control in manufacturing.
The present invention excels in responding to dynamic environments featuring moving objects. Its ability to track and understand the movement of 3D objects contributes to efficient real-time decision-making, making it well-suited for applications like autonomous navigation and surveillance.
The present invention fosters effective collaboration between humans and robots by providing precise object perception. This contributes to safer and more efficient interactions in shared workspaces, where robots can accurately perceive and respond to human activities.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

We claim:

1. A method for determining a visual perception of one or more 3-dimensional (3D) objects in an environment, the method comprising:
segmenting the one or more 3D objects into segmented data comprising of one or more rigid objects and one or more non-rigid objects in a user input using a segmentation machine learning (ML) model, wherein the user input indicates a representation of the environment;
determining a position and a shape corresponding to each of the segmented one or more 3D objects based on an orientation of the segmented one or more 3D objects, the user input, and a corrected segmented point cloud data, wherein the position and a shape includes a set of key points indicating spatial characteristics of the segmented one or more 3D objects such that the position indicates a set of coordinates, and the shape indicates a sequence of the set of key points;
tracking a movement of the segmented one or more 3D objects based on the set of key points, the corrected segmented point cloud data, and a motion value corresponding to a manipulator attached to the one or more 3D objects; and
determining the visual perception of the segmented one or more 3D objects based on the tracked movement and the set of key points, wherein the visual perception indicates the shape and a location of the one or more rigid objects and the one or more non-rigid objects in the environment.

2. The method as claimed in claim 1, comprising generating a segmented point cloud data indicating a contour of the segmented one or more 3D objects using the segmentation ML model, wherein generating the segmented point cloud data comprises:
receiving the user input from a camera sensor, wherein the user input includes at least one of a 3-dimensional data, a color data, and a depth data;
generating a segmented data using the segmentation ML model, wherein the segmented data indicates the segmented one or more 3D objects delineated and labelled based on a training of the segmentation ML model; and
generating the segmented point cloud data based on the segmented data such that the segmentation ML model identifies and isolates the contour for each of the segmented one or more rigid objects and one or more non-rigid objects respectively.

3. The method as claimed in claim 2, wherein training the segmentation ML model comprises:
generating a point-cloud data using a simulation of a plurality of real-world 3D objects in the environment, wherein the point-cloud data indicates spatial information of the plurality of real-world 3D objects; and
generating a training-set based on the point-cloud data and annotation of the plurality of real-world 3D objects into the one or more rigid objects and the one or more non-rigid objects respectively.

4. The method as claimed in claim 1, further comprising:
correcting errors in the segmented data based on an image processing technique to provide corrected one or more 3D objects; and
determining a set of key points corresponding to each of the corrected one or more 3D objects by a feature and shape detection module, wherein the set of key points comprises at least one of edges, surface landmarks, junctions, protuberances, high curvature points, indicating the spatial characteristics of the segmented one or more 3D objects.

5. The method as claimed in claim 4, wherein the spatial characteristics indicate at least one of a rigid and a non-rigid part of the corresponding segmented one or more 3D objects.

6. The method as claimed in claim 1, comprising determining the orientation indicating a spatial positioning and alignment of the segmented one or more 3D objects based on the corrected segmented point cloud data.

7. The method as claimed in claim 1, wherein tracking the movement of the segmented one or more 3D objects comprises:
comparing a corrected set of key points at a first timestamp, the corrected segmented point cloud data at a second timestamp, and the motion value of the manipulator;
determining a spatial transformation indicative of aligning the set of key points at the first timestamp and the segmented point cloud data at the second timestamp based on comparing; and
tracking the movement of the segmented one or more 3D objects based on the spatial transformation.

8. The method as claimed in claim 7, wherein determining the spatial transformation using the Coherent Point Drift (CPD) technique.

9. A system for determining a visual perception of one or more 3-dimensional (3D) objects in an environment, the system comprising:
a memory;
at least one processor in communication with the memory, wherein the at least one processor is configured to:
segment the one or more 3D objects into segmented data comprising one or more rigid objects and one or more non-rigid objects in a user input using a segmentation machine learning (ML) model, wherein the user input indicates representation of the environment;
determine a position and a shape corresponding to each of the segmented one or more 3D objects based on an orientation of the segmented one or more 3D objects, the user input, and a corrected segmented point cloud data, wherein the position and the shape includes a set of key points indicating spatial characteristics of the segmented one or more 3D objects such that the position indicates a set of coordinates, and the shape indicates a sequence of the set of key points;
track a movement of the segmented one or more 3D objects based on the set of key points, the corrected segmented point cloud data, and a motion value corresponding to a manipulator attached to the one or more 3D objects; and
determine the visual perception of the segmented one or more 3D objects based on the tracked movement and the set of key points, wherein the visual perception indicates the shape and a location of the one or more rigid objects and the one or more non-rigid objects in the environment.

10. The system as claimed in claim 9, comprising the at least one processor configured to generate a segmented point cloud data indicating a contour of the segmented one or more 3D objects using the segmentation ML model, wherein the at least one processor is configured to:
receive the user input from a camera sensor, wherein the user input includes at least one of a 3-D data, a color data, and a depth data;
generate a segmented data using the segmentation ML model, wherein the segmented data indicates the segmented one or more 3D objects delineated and labelled based on a training of the segmentation ML model; and
generate the segmented point cloud data based on the segmented data such that the segmentation ML model identifies and isolates the contour structure for each of the segmented one or more rigid objects and one or more non-rigid objects respectively.

11. The system as claimed in claim 10, wherein to train the segmentation ML model, the at least one processor is configured to:
generate a point-cloud data using a simulation of a plurality of real-world 3D objects in the environment, wherein the point-cloud data indicates spatial information of the plurality of real-world 3D objects; and
generate a training-set based on the point-cloud data and annotation of the plurality of real-world 3D objects into the one or more rigid objects and the one or more non-rigid objects respectively.

12. The system as claimed in claim 9, further comprising: correcting errors in the segmented data comprising the one or more segmented 3D objects based on an image processing technique to provide corrected one or more 3D objects; and determine the set of key points corresponding to each of the corrected one or more 3D objects by a feature and shape detection module, wherein the set of key points at least one of edges, surface landmarks, junctions, protuberances, high curvature points, indicating the spatial characteristics of the segmented one or more 3D objects.

13. The system as claimed in claim 12, wherein the spatial characteristics indicate at least one of a rigid and a non-rigid part of the corresponding segmented one or more 3D objects.

14. The system as claimed in claim 9, comprising the at least one processor configured to determine the orientation indicating a spatial positioning and alignment of the segmented one or more 3D objects based on the corrected segmented point cloud data.

15. The system as claimed in claim 9, wherein to track the movement of the segmented one or more 3D objects, the at least one processor is configured to:
compare a corrected set of key points at a first timestamp, the corrected segmented point cloud data at a second timestamp, and the motion value of the manipulator;
determine a spatial transformation indicative of aligning the set of key points at the first timestamp and the corrected segmented point cloud data at the second timestamp based on comparing; and
track the movement of the segmented one or more 3D objects based on the spatial transformation.

16. The system as claimed in claim 15, wherein the at least one processor is configured to determine the spatial transformation using the Coherent Point Drift (CPD) technique.
